(19) United States
(12) Patent Application Publication
(10) Pub. No.: US 2013/0290114 A1
(43) Pub. Date: Oct. 31, 2013

(54) METHODS AND SYSTEMS FOR GENERATING A BRAND USING CONTEXTUAL INFORMATION

(71) Applicant: PrestoBox Inc., Portland, OR (US)

(72) Inventors: Elicia Putnam, Portland, OR (US); Sara Conte, Portland, OR (US)

(21) Appl. No.: 13/874,292

(22) Filed: Apr. 30, 2013

Related U.S. Application Data
(60) Provisional application No. 61/640,125, filed on Apr. 30, 2012.

(51) Int. Cl. G06Q 30/02

(52) U.S. Cl. CPC G06Q 30/0276
USPC 705/14.72

(57) ABSTRACT

Methods and systems of generating a brand via a computer interface are disclosed. A first plurality of inputs are received from a user in response to a first plurality of prompts. The inputs are analyzed and a brand uber-archetype is selected. A second plurality of prompts is provided and corresponding inputs are received and analyzed. A brand sub-archetype is then selected and branded content is produced in accordance with the selected sub-archetype. The user may then refine the selection if desired.

### PRIORITY CLAIM

This application claims priority to U.S. provisional application No. 61/640,125, filed Apr. 30, 2012, the entire disclosure of which is hereby incorporated by reference for all purposes.

### BACKGROUND

Branding is important for most companies worldwide. A brand represents a promise to customers and to the public. It represents the company's goods and services—and is symbolic for what the public can expect from the company. Strong brands usually result in significant value creation for companies. Customers are usually willing to pay a higher price for well-branded products because they learn to trust and rely on the brand promise. When the company delivers on its brand promise, customers are well served and make repeat purchases. This results in higher sales for the company.

Advertising agencies and marketing firms have been paid millions to define and create brands. However, small companies and individuals do not have access to these often expensive and time-intensive processes. These users go in search of branding and marketing solutions in a vacuum—without custom design and without the expertise to develop effective marketing materials based on their unique brand promise. The system and method described herein allows a wide-variety of users affordable, easy access to high-end brand creation. It provides users with the custom branding solution they require and a professionally designed toolkit for their marketing and communication needs.

Creating and defining brands has been an art of advertising, marketing and creative agencies for years. It is usually an expensive process that requires hours of senior management and other employee input. There are many ways to coach a company toward a defined brand. It is usually a subjective, qualitative and often indirect path. However, when the right combination of technique and company input are utilized, the results are powerful.

An agreed-upon brand platform creates a powerful—and sustainable—way to connect with external and internal audiences. It also serves as a critical foundation for ensuring all marketing materials have a common voice and expression.

Brand definition is typically an art, not a specific science. It requires human input, emotion, team collaboration and experience to be done right. Traditionally this has been completed in a purely offline process. Companies struggle most with finding alignment on the intangibles or the emotions of a brand. Why is this important? Research shows that people make choices based on reason, but they only take action based on emotion. Brands that successfully tap into customer emotions usually have far more impact in the marketplace.

One of the problems with this traditional approach is that it is expensive and is not easily accessible for companies with smaller budgets. It has not been automated, or available to a larger scale user base.

Another problem is that it takes years of experience to be able to define and constantly update a proper set of questions to guide companies through the process of defining a brand. The process must be continually updated as competing brands and other situations change.

### BRIEF DESCRIPTION OF THE DRAWINGS

Various embodiments in accordance with the present disclosure will be described with reference to the drawings, in which:

FIG. 1 is a schematic diagram of an exemplary computing environment which may benefit from the use of various aspects of exemplary embodiments of the present methods and systems;

FIG. 2 is a flow chart depicting the process of automatically generating a brand using contextual information in accordance with the present methods and systems; and

FIG. 3 is a schematic diagram depicting aspects of a non-limiting, exemplary computing architecture suitable for implementing at least some embodiments of the present methods and systems.

### DETAILED DESCRIPTION

This description discusses various illustrative embodiments of the present methods and systems for generating a brand using contextual information (the “present methods and systems”) with reference to the accompanying drawings in order to provide a person having ordinary skill in the relevant art with a full, clear, and concise description of the subject matter defined by the claims which follow, and to enable such a person to appreciate and understand how to make and use the same. However, this description should not be read to limit the scope of the claimed subject matter, nor does the presence of an embodiment in this description imply any preference of the described embodiment over any other embodiment, unless such a preference is explicitly identified herein. It is the claims, not this description or other sections of this document or the accompanying drawings, which define the scope of the subject matter to which the inventor and/or the inventor's assignee(s) claim exclusive rights.

In accordance with at least one embodiment of the present methods and systems, a user may provide a brand generation engine with a series of inputs that the brand generation engine may analyze, weigh, summarize and/or compare to a database of brand archetypes and platforms in order to generate a corresponding brand. The brand generation engine may characterize the user's inputs as belonging to a particular brand archetype with a corresponding personalized brand design. Embodiments of a brand generation engine corresponding to aspects of the present methods and systems may receive input from multiple users from the same group (e.g. from the same company or organization) as part of the process to define the group's brand. Specific aspects of the brand platform may be further refined as the user makes individual choices on design within the initially established brand scope. Embodiments of the present methods and systems permit the provision of a highly developed branding service that is scalable to large audiences of users.

In accordance with aspects of the present methods and systems, input from multiple may be incorporated into the brand definition. The algorithm may weight and further analyze the composite results of the group and will recommend the best matching brand definition.

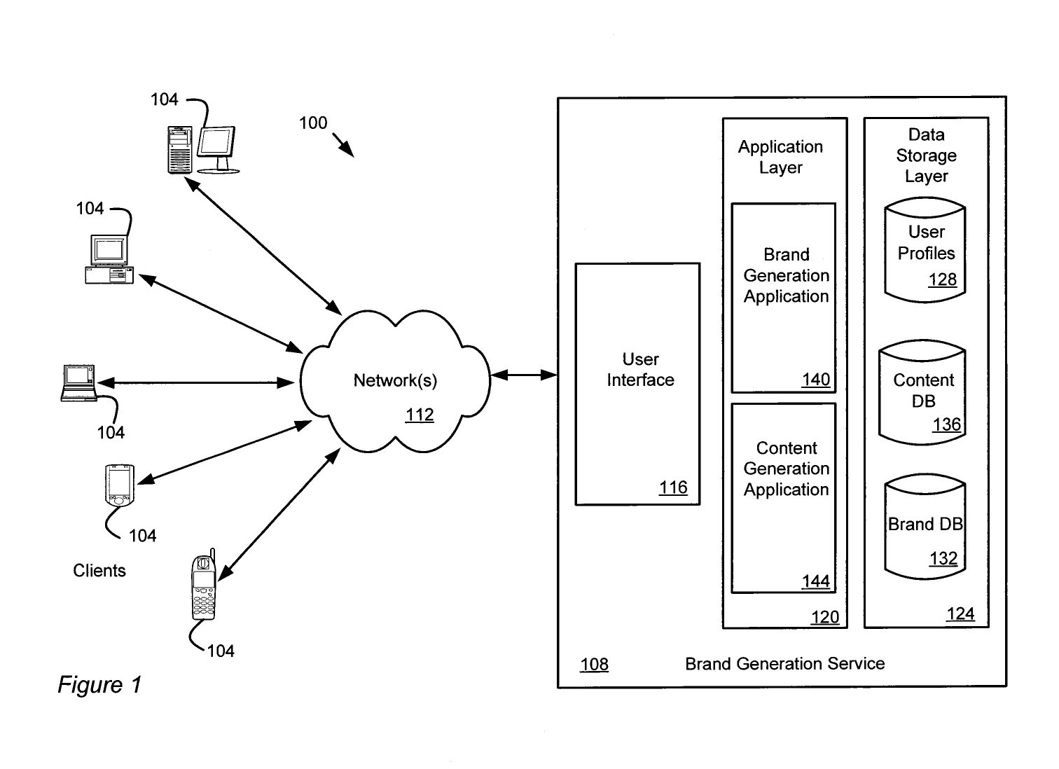

FIG. 1 depicts aspects of an exemplary computing environment 100 in accordance with at least one embodiment of the present methods and systems. A variety of client applications (not shown) incorporating and/or incorporated into a variety of computing devices 104 may communicate with a brand generation service 108 through one or more networks 112. Examples of suitable computing devices 104 include personal computers, server computers, desktop computers, laptop computers, notebook computers, personal digital assistants (PDAs), smart phones, cell phones, computers, and consumer electronics incorporating one or more computing device components such as one or more processors. Examples of suitable networks include networks including wired and wireless communication technologies, networks operating in accordance with any suitable networking and/or communication protocol, private intranets and/or the Internet. The network 112 is not limited to a particular type and may include wide area networks (WANs) such as the Internet, or local area networks (LANs) such as Ethernet, or other networks.

The brand generator service 108 may include multiple processing layers including a user interface layer 116, an application layer 120 and a data storage layer 124. The user interface layer 116 may permit users to interact with the other components of the service via client applications, including graphical user interfaces and/or web-based interfaces. The data storage layer 124 may include a user profile database 128, a brand database 132, and a content database 136. Databases may be implemented with any suitable data storage technology including structured query language (SQL) based relational database management systems (RDBMS). Each processing layer of the brand generation service 108 may be implemented by a distributed set of computers and/or computer components including computer servers.

Certain aspects of the present methods and systems may be embodied by a brand generation application 140 in the application layer 120. When a user utilizes the brand generator service 108, the brand generation application 140 will present the user with a series of defining questions. In response to the user's answers, the brand generation application 140 will progressively select additional questions to more accurately define a brand archetype for the user. Once a brand archetype is defined, a content generation application 144 will provide coinciding content for the defined archetype, such as pre-defined colors, fonts and images associated with the defined archetype. The content generation application 144 may search the content database 136 for content matching the defined archetype. This content may be used to further generate a variety of products for a marketing toolkit, which may be provided to the user. This may include items such as a website, brochures, business cards, a marketing dashboard and other content, all themed consistently with the defined archetype.

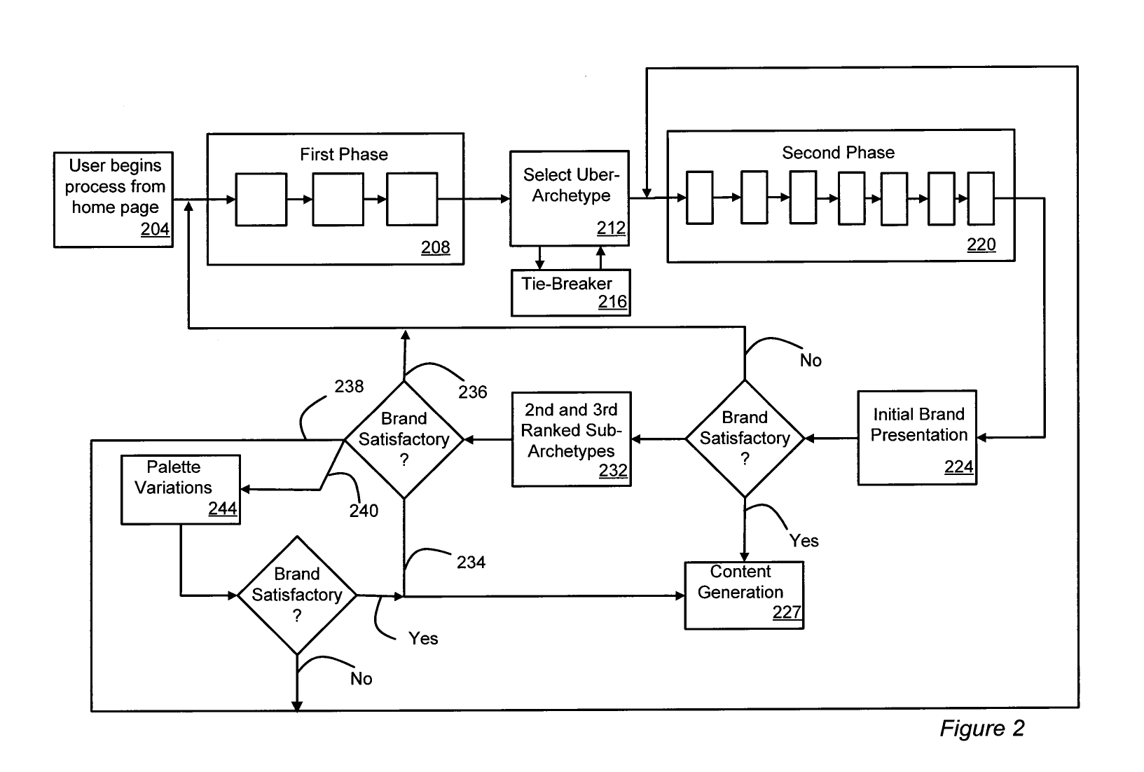

FIG. 2 depicts a process flow 200 for providing a user of a brand generation service embodying the present methods and systems with a series of questions which generate responsive inputs to a brand generation algorithm. The process 200 takes a time-intensive offline, brand discovery process and automates it through a series of unique questions designed to lead the user down a path to a specific brand archetype. The series of questions may be successively limiting and result in a brand definition representative of the collective users' aspirations, expectations and customer promises for the group. The defined brand created by the process may include, by way of non-limiting example, archetype, fonts, images, conceptual descriptions, marketing materials, and a platform.

In some embodiments of the present methods and systems, from the homepage 204, during the first phase 208 of the brand generation process the user answers an initial series of questions designed to determine the user's brand archetype and to begin the process of identifying the user's particular brand expression. The first phase 208 may consist of three questions. The brand generation application then matches each answer with a corresponding brand uber-archetype according to predefined associations 212. The uber-archetype may be viewed as a first pass at defining the over-arching brand type for the user. There may, for example, be six possible uber-archetypes defined in the brand generation system. Non-limiting examples of such uber-archetypes may be: Traditional, Leader, Innovation, Elegance, Caregiver and Play. In the present, non-limiting, example, the questions in the first phase 208 are equally weighted and each answer is associated with an uber-archetype and whichever uber-archetype is chosen most frequently wins. For example, if two of the user's answers correspond to “Traditional” two correspond to “Innovation”, four answers correspond to “Caregiver,” and one to “Play,” then “Caregiver” is selected as the uber-archetype because it was chosen the most frequently. In the case of a tie, a tie-breaker question may be presented to the user 216. In an exemplary embodiment of the present methods and systems, the user is limited to one uber-archetype category.

The second phase 220 of the process may be a second series of questions determined by the previously defined uber-archetype. The second phase is designed to further narrow the brand definition within the uber-archetype to determine a brand sub-archetype. Each of the answers to the questions corresponds with one of several pre-defined sub-archetypes. For example, if, as discussed above, the system has selected “Caregiver” as the user brand's uber-archetype, the second phase may determine whether the brand sub-archetype should be “Rockwell Painting,” “Town Square,” “Everyday Joe,” “Rustic Simplicity,” “The Good Earth,” “Nest of Eggs,” or “Place of Zen.”

In one example, during the second phase 220 the user goes through a series of seven questions and selects answers that the brand generation application associates with a corresponding to a specific sub-archetype. The user is asked to choose between one to five answers per question. Each time an answer is selected, the brand generation application records the associated sub-archetype. Each of these answers may be equally weighted and the sub-archetype that is selected most frequently may determine the appropriate sub-archetype.

Once the uber-archetype and sub-archetype are defined, the user may be presented with an initial version of the personalized brand definition, content, and design 224. If the user indicates the presented version of the brand definition matches the user's vision of the brand 226, the content generation application may create and present a marketing toolkit may be presented with a series of products for the user 227. These products may include, but are not limited to, a sample website, business cards, brochures, marketing dashboards, newsletters, and email campaigns.

In accordance with embodiments of the present methods and systems, the user may also have the ability to refine the generated brand 228, for example by indicating if the preliminarily generated brand is significantly wrong or close but in need of adjustment. In the former case, the user can begin the process again at the first phase 208. In the latter, the user is prompted to examine the second and third highest scoring sub-archetypes within the uber-archetype category 232. The user may then choose whether either of these selections is a good match for the brand. If the user indicates either one of these sub-archetypes matches the desired brand 234, the user is directed to the content generation application 227. If neither are a good match 236, the user will be directed to begin the process again at the first phase 208. If the user judges the second and third highest scoring selections to be close but not preferable 238, the brand generation application assumes that previously identified uber-archetype category is correct and the user is directed back to reinitiate the second phase 220. If the user indicates one of these sub-archetypes is preferred, but still not satisfactory, 240 the user may be prompted to examine various palette variations of the preferred sub-archetype 244.

Palette Variations include slightly adjusted fonts, images and colors that remain suitable within the preferred sub-archetype definition. At the conclusion of this process, the user will again decide whether the brand definition being presented is acceptable. If so, the user will be directed to the content generation application 227. If not, the user will be directed to begin again at the first phase 208. If the user indicates further refinement is needed, the user will be directed to examine the second and third highest ranked sub-archetypes 232.

Upon being directed to the content generation application 227, the user may be presented with a brand kit including a suite of marketing products that will be pre-loaded with the user's personalized brand design in accordance with the selected archetype. This may include templates for marketing, advertising and communication tools such as websites, brochures, business cards, marketing dashboards, email marketing and more. The user information (archetype, name, contact, interests, other) may be stored so the user can return to the site in the future to reference and further develop these tools.

As discussed above, embodiments of the present methods and systems may lead a user (or multiple users) through a series of questions that will result in a specific brand definition. The specific brand-defining questions are pre-defined and may advantageously be based on methodologies targeted at defining the subjective intangibles or emotional parameters of the group being branded, as viewed collectively by the group itself. The answers to the questions may be weighted, or further quantitatively analyzed to produce the correct brand definition for the user.

The following questions are provided as non-limiting examples and will vary based on results and user choice.

In the first phase, the user may be asked, “Which words describe your company?” and prompt the user select one or more applicable words from a set of possible answers. For example, the user may be presented with thirty six possible answers and asked to select the five most applicable words. Each word is associated with a pre-defined uber-archetype. The user can choose words freely, but is likely to choose complementary words to define its brand, such as “genuine” and “honest”. The user is unlikely to choose conflicting words, such as “safe” and “daring”, or “carefree” and “conscientious”.

A second question to the user may be, “Which companies do you admire?” and the user may be asked to select three companies from a list of well known companies. Again, each possible answer corresponds to a different uber-archetype. A third question may be, “What does your company feel like?” In this case, the user may be limited to choosing only one answer and again each possible answer is associated with an uber-archetype.

During the second phase, the user may be presented with the question and then asked to select one of several possible answers, each corresponding to a different sub-archetype within the previously selected uber-archetype. Questions (and answers) such as:

“Which body of water best represents your company?” (“lake,” “community swimming pool,” “fishing hole,” “mountain stream,” “raindrop,” “bird bath,” or “reflecting pool”)

“Which writing instrument best represents your company?” (“old fashioned typewriter,” “ballpoint pen,” “pencil,” “charcoal,” “stick,” “colored pencil,” or “paintbrush”)

“Which animal best represents your company?” (“golden retriever, “chocolate Labrador,” “bloodhound,” “coyote,” “ant,” or “koala bear”)

“Which mode of transportation best represents your company?” (“cruiser bike,” “tandem bike,” “pick-up truck,” “hay wagon,” “horse & buggy,” or “canoe”)

“Which object best represents your company?” (“marble,” “pot of coffee,” “can opener,” “ball of twine,” “packet of seeds,” or “glass egg”)

In another style of second phase question, the user may be asked to choose more than one answer from a set of answers. For example, the user may be asked, “Who could be a spokesperson for your company?” or “What image best represents your company?” and be respectively presented with a set of well-known names or images. The user may, for instance, be asked to select three names from a set of twenty one names.

In one example, each sub-archetype corresponding to the selected answers is equally weighted. After completing the second phase questions, the sub-archetype selected most frequently is selected as the user's sub-archetype. The user may then be presented with a concise, descriptive definition of the selected brand definition, including basic terms, adjectives, comparable brands, etc. The definition also includes sample images associated with the brand, appropriate colors and recommended typographies. The user can utilize these images and descriptors as it conveys its brand promise publicly.

As described above, after the iteration of questions the user will have the opportunity to then decide whether this presented brand platform is a good match and refine it if necessary. If it is not a good match the user will be able to re-start the process to more accurately answer the questions in line with their brand vision. If there are elements that feel right, but not entirely, the user will have the ability to go back through to define its sub-archetype within the uber-archetype already selected. If the match is close, the user will have the ability to see other variations of the brand design. If the design is a good match, the user may proceed to the content generation application, which can begin to collect information and customize the final details of the brand platform and toolkit. The user may be served various options that have variations of the brand design. Within these options, the user can choose the design that is the closest match to the brand platform.

The various aspects and embodiments described above are specific but not exclusive examples of how the present methods and systems may be implemented and the advantages gained therefrom. However, persons having ordinary skill in the art will recognize that the teachings present methods and systems are equally applicable to other embodiments and/or may be similarly described using alternate terminology.

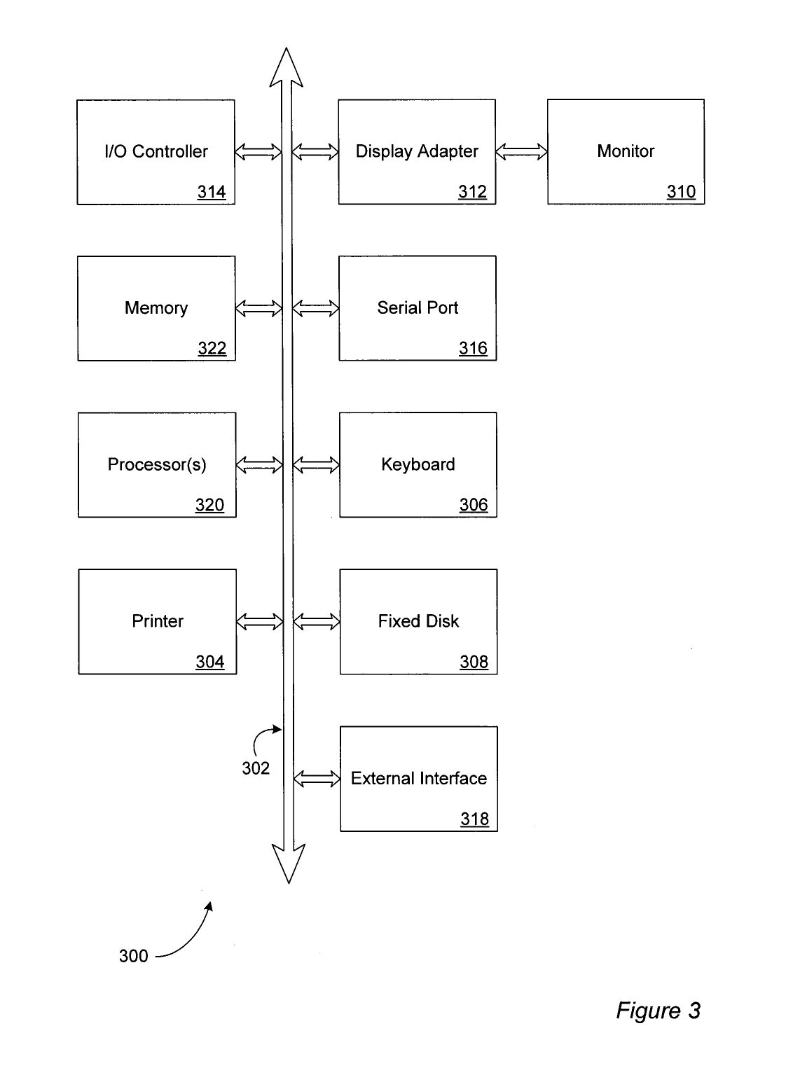

By way of a non-limiting example, FIG. 3 depicts aspects of elements that may be present in a computer device and/or system 300 configured to implement a method and/or process in accordance with some embodiments of the present invention. The subsystems shown in FIG. 3 are interconnected via a system bus 302. Additional subsystems include a printer 304, a keyboard 306, a fixed disk 308, and a monitor 310, which is coupled to a display adapter 312. Peripherals and input/output (I/O) devices, which couple to an I/O controller 314, can be connected to the computer system by any number of means known in the art, such as a serial port 316. For example, the serial port 316 or an external interface 318 can be utilized to connect the computer device 300 to further devices and/or systems not shown in FIG. 3 including a wide area network such as the Internet, a mouse input device, and/or a scanner. The interconnection via the system bus 302 allows one or more processors 320 to communicate with each subsystem and to control the execution of instructions that may be stored in a system memory 322 and/or the fixed disk 308, as well as the exchange of information between subsystems. The system memory 322 and/or the fixed disk 308 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++, or Perl, using, for example, conventional or object-oriented techniques. The software code may be stored as a series of instructions, or commands on a computer readable medium, such as a random access memory (RAM) a read-only memory (ROM), a magnetic medium such as a hard-drive, a solid-state device such as a flash memory drive, or an optical medium such as a CD-ROM. Any such computer readable medium may reside on or within a single computational apparatus, and may be present on or within different computational apparatuses within a system or network.

Exemplary embodiments of the present methods and systems have been described in detail above and in the accompanying figures for illustrative purposes. However, the scope of the present methods and systems are defined by the claims below and is not limited to the embodiments described above or depicted in the figures. Embodiments differing from those described and shown herein, but still within the scope of the defined methods and systems are envisioned by the inventors and will be apparent to persons having ordinary skill in the relevant art in view of this specification as a whole. The inventors intend for the defined methods and systems to be practiced other than as explicitly described herein. Accordingly, the defined methods and systems encompass all modifications and equivalents of the subject matter as permitted by applicable law.

That which is claimed is:

1. A method of generating a brand via a computer interface comprising:
(a) receiving a first plurality of inputs from a user in response to a first plurality of prompts, each of said first plurality inputs being associated with at least one brand uber-archetype;
(b) analyzing said first plurality of inputs and selecting a brand uber-archetype for said user, said selection being dependent on said analysis of said first plurality of inputs;
(c) providing said user with a with a second plurality of prompts, said second plurality of prompts being dependent on said selected brand uber-archetype;
(d) receiving a second plurality of inputs from said user in response to said second plurality of prompts;
(e) analyzing said second plurality of inputs and selecting a brand sub-archetype for said user, said selection being dependent on said analysis of said second plurality of inputs; and
(f) generating a set of branded content in accordance with said selected brand sub-archetype and providing said branded content to said user, and
wherein each step is accomplished via interaction through said computer interface between said user and one or more computer software components.

2. The method of claim 1, wherein step (e) comprises ranking a plurality of brand sub-archetypes in accordance with a determined user preference and, if the user indicates the provided content is unsatisfactory, the method further comprises providing said user with at least one set of alternative content in accordance with at least one alternative brand sub-archetype based on said ranking.

3. The method of claim 1, wherein if the user indicates the provided content is unsatisfactory, repeating the process from step (c).

4. The method of claim 1, wherein if the user indicates the provided content is unsatisfactory, repeating the process from step (a).

5. The method of claim 1, wherein said selected brand sub-archetype is selected from one of a plurality of predefined sets of sub-archetypes, each set of sub-archetypes being associated with a predefined brand uber-archetype.

6. A system for generating a brand, the system comprising:
(a) a user interface,
(b) a brand generation component, and
(c) a content generation component, and
wherein said user interface enables an exchange of data between a user and said brand generation component and said content generation component, said brand generation component selects a brand uber-archetype and a brand sub-archetype in response to data collected from said user and said content generation component generates branded content for said user in accordance with said selected brand sub-archetype.

7. The system of claim 6, wherein said brand generation component determines a ranking a plurality of brand sub-archetypes according to perceived user preferences, said selected brand sub-archetype corresponds to the highest ranked of said plurality of brand sub-archetypes, and, if said user indicates content generated in accordance with said selected brand sub-archetype is unsatisfactory, said content generation component generates additional content in accordance with at least one additional brand sub-archetype according to said ranking.

8. The system of claim 6, wherein, if said user indicates content generated by said content generation component is unsatisfactory, said brand generation component selects a new brand sub-archetype in response to additional data collected from said user.

9. The system of claim 6, wherein, if said user indicates content generated by said content generation component is unsatisfactory, said brand generation component selects a new brand uber-archetype in response to additional data collected from said user.

10. The system of claim 6, wherein said selected brand sub-archetype is selected from one of a plurality of predefined sets of sub-archetypes, each set of sub-archetypes being associated with a predefined brand uber-archetype.
